(19) United States
(12) Patent Application Publication
(10) Pub. No.: US 2023/0116050 A1
(43) Pub. Date: Apr. 13, 2023

(54) Modular Interactive Dynamic Content Display and System

(71) Applicant: Dana Blads, Poinciana, FL (US)

(72) Inventor: Dana Blads, Poinciana, FL (US)

(21) Appl. No.: 17/964,908

(22) Filed: Oct. 12, 2022

Related U.S. Application Data
(60) Provisional application No. 63/262,446, filed on Oct. 12, 2021.

(51) Int. Cl. H04N 21/431; H04N 21/81; H04N 21/4782

(52) U.S. Cl. CPC H04N 21/4316; H04N 21/8133; H04N 21/4782; H04N 21/812

(57) ABSTRACT

Display device with a system platform having, modular and interactive content providing a plurality of viewer and interactive modes. Multimedia content and related social media and advertisement content are simultaneously displayed, accessed, and interacted with by a viewer. A viewer can also interact with a browser. The system platform integrates with a broadcast television platform.

### CROSS REFERENCE TO R ELATED APPLICATION

This U.S. non-provisional application claims priority to U.S. provisional application No. 63/262,446 entitled the same and having a filing date of Oct. 12, 2021, the entire contents of which are incorporated by reference.

### FIELD OF THE DISCLOSURE

The present disclosure relates to systems for dynamic content display and interaction. More specifically, the system pertains to multimedia content delivery and linkage to newsworthy topics, trending social media content, and interactive advertisements related to the multimedia content.

### BACKGROUND OF THE DISCLOSURE

Digital media and entertainment are a major part of everyday life. Broadcasted television, streaming movies and shows, social media, and product and service discovery through sponsored. posts and advertisements are omnipresent. Traditionally, movies and television programs are viewed on streaming platforms or broadcast networks displayed on a screen. The screen is typically a television, computer, tablet, or other smart device.

Multimedia content delivery provides opportunities for content providers and platform providers to generate revenue though selling advertisement space, and products and services providers generate conversions and sales by investing in the advertisement space. In other words, advertising opportunities center around and bank on viewers tuning in to the multimedia content.

On social media platforms focused on streaming multimedia content such as histogram, Facebook, and TikTok, advertisements are displayed to the viewer based on viewer preferences, likes, and browsing history. Viewers of the same multimedia content may not be shown thesame advertisements. In many cases, the advertisements displayed are not related to the multimedia content the viewer is interested in. Therefbre, a major drawback is a lack of contextual relationship or relevance between the viewer and the viewer's interests and the multimedia content.

Another drawback to traditional multimedia streaming and viewing is the disconnect between the content, social interaction, and relevant products and services. For example, television networks promote season premieres or reunions with trending hashtags on social media such as Twitter. Traditionally, viewers use an additional device such as a smart phone or a computer to view and interact with the trending social media content. Specifically, a viewer will access the social media interface and manually search for the trending hash tag before engaging in discussion with other social media users also viewing the same show or movie.

### SUMMARY OF THE DISCLOSURE

What is needed is an integrated multimedia system where viewers can view and interact with integrated content on the same multimedia content device display. The multimedia content device receives multimedia content from a provider and displays the content on a graphical user interface. The content contains references to trending topics, goods, and services or other contextual relevance to displayed television broadcast content. A dynamic display provides a television mode, an Internet/browser mode, and an interactive mode comprising customizable widgets.

The system platform has operably configured software for generating on a display device an interactive multimedia graphical user interface containing a partition separating television broadcasttent and interactive content having a contextual relationship.

The system platform comprises a processor configured to execute programmatic instructions that when executed request television broadcast content metadata from a television broadcast platform in wireless communication with the system platform over a network interface, receive television broadcast content metadata from the television broadcast platform via the network interface, transmit instructions to generate and display on the display device a graphical user interface having a partition between a broadcast content section and an interactive content section, identify third-party content modules, load a third-party content module having an API and metadata, and match context-specific metadata from the broadcast content metadata to content module metadata.

Third-party content modules are advertisement, social media, or browser modules having their respective APIs and metadata.

### BRIEF DESCRIPTION OF THE DRAWINGS

The accompanying drawings that are incorporated in and constitute a part of this specificationillustrate several embodiments of the disclosure. Together with the description, they serve to explain the principles of the disclosure.

FIG. 1 illustrates a schematic of an exemplary system.

FIG. 2 illustrates an exemplarytelevision mode on a multimedia display device.

FIG. 3 illustrates an exemplary Internet browser mode on a multimedia display device,

FIG. 4 illustrates an exemplary interactive mode on a multimedia display device.

FIG. 5 illustrates an exemplary schematic of multimedia content access, interaction, and display.

FIG. 6 illustrates an alternative exemplary embodiment of multimedia content access, interaction, and display.

FIG. 7 illustrates an exemplary browser with picture-in-picture display.

FIG. 8 Illustrates an alternative exemplary browser with picture-in-picture display.

FIG. 9 illustrates a schematic of programmatic instructions and content.

FIG. 10 illustrates an exemplary picture-in-picture section interface.

FIG. 11 illustrates an exemplary schematic of integration of a system platform with a broadcast television platform.

### NUMERALS OF THE FIGURES

1. System platform

3. Display device

5. Control device

7. Internet connection

9. Browser module

11. Social media module

13. Advertisement module

15. Television broadcast content

17. Database and server

19. Content delivery network

21. Display

23. Television broadcast content section

25. Browser content section

27. Picture-in-picture section.

29. Interactive content section

31. First third-party module

33. Section third-party module

35. Third third-party module

37. Partition

39. Navigation panel

41. Cursor

43. Activate display device with graphical user interface

45. Select content or mode widgets and partition screen

47. Request content via a networkit tertace

49. Interactive module with third-party API and metadata

51. Television module with television broadcast cor tent, API, and metadata

53. Internet browser module with third-party API and metadata

55. Coordinate television broadcast content with module Metadata

57. Transmit and display content on graphical user interface

59. Close function

61. Sound function

63. Minimize/max function

65. Full screen function

67. Settings function

69. Broadcast television platform

71. Network interface between broadcast television platform and system platform

73. Internet connection

75. Display device

77. System platibim with operably configured software

79. Network interlace between system platform and third-party modules

81. Interactive module with third-party API and metadata

### DETAILED DESCRIPTION

The exemplary system generally comprises a multimedia display device capable of switching to television mode, to interactive mode, and to Internet/browser mode. A viewer can access and interact with television content, social media content, and advertisements simultaneously via the display of the respective modules on. segmented or compartmentalized portions of the multimedia display device. The social media content and the advertisement content is contextually related to the multimedia content.

In each mode or module, the system facilitates the push and pull of data for real-time content display and interaction in a context related to the displayed multimedia content such as a television show, movie, commercial, or live stream.

The exemplary system platform integrates with a broadcast television platform via communication via a network interface. The system platform has operably configured software with programmatic instructions to generate a graphical user interface that partitions a display into a television broadcast section and an interactive section on a display device. The interactive section comprises interactive widgets from content modules having their own respective APIs and metadata.

The modules can be manually selected and displayed by a viewer or can be automatically selected and displayed according to matching metadata from the television broadcast to the metadata in the module content. Metadata includes keywords and phrases, date and time, episode number and characters, production companies, television channel and network, social media handles, hashtags, brand names, sport team names, browser search history and cookies, viewer-entered information, trending topics, demographics, geotags, and IP addresses.

In the following sections, detailed descriptions of examples and methods of the disclosure will be given. The description of both preferred and alternative examples is exemplary only, and it is understood that to those skilled in the art that variations, modifications, and alterations may be apparent. It is therefore to be understood that the examples do not limit the broadness of the aspects of the underlying disclosure as defined by the claims.

### Detailed Descriptions of the Drawings

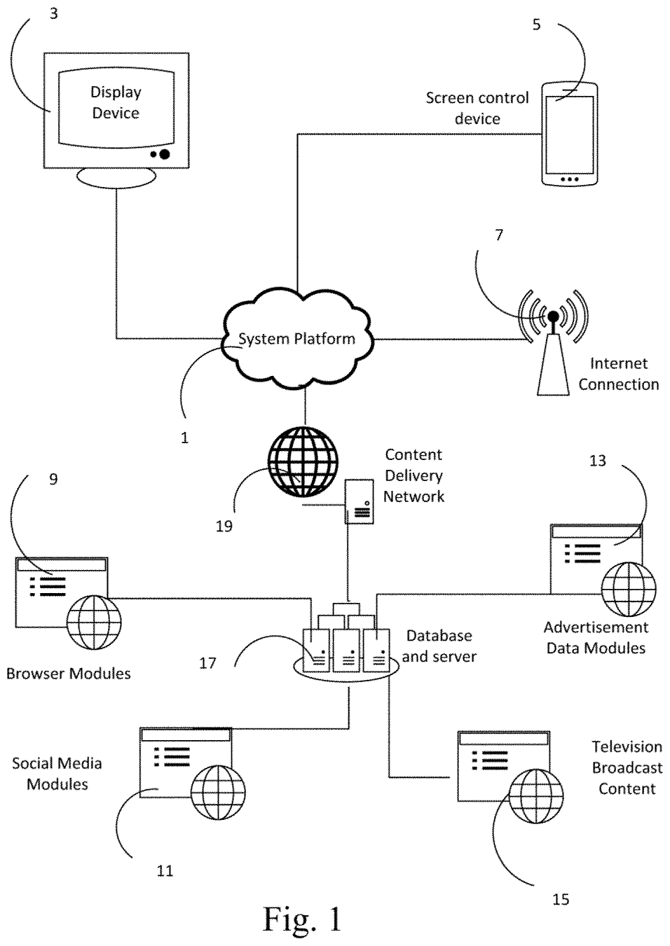

Referring now to FIG. 1, a schematic of an exemplary system is shown. Generally, the system comprises a multimedia display device, an Internet connection and content delivery network, a screen control device, social media modules, browser modules, advertisement data, and at least one database that may contain at least one API for identifying and linking advertising and social media content to the displayed multimedia content.

Multimedia display devices may comprise one or more storage subsystems comprising hardware and software components used for storing data and program instructions such as system memory and computer-readable storage media. The system memory and/or computer-readable storage media may store program instructions that are loadable and executable on processors, as well as data generated during the execution of exemplary programs. Bus subsystems provide a mechanism for letting the various components and subsystems of the exemplary computer system communicate with each other as intended to facilitate social media, advertisement, and multimedia data push and pull.

To produce interrelated content accessed from modules or widgets, the system comprises a processor configured to execute instructions for receiving multimedia input data, identifying products and services components, accessing social media accounts, and identifying trending topics related to the multimedia content. Computer-executable instructions include, for example. instructions and data which cause any device, computer, or special purpose processing device to perform a certain function or group of functions. Computer-executable instructions include program, platform, and application modules that are executed by computers in stand-alone or network environments.

Generally, program modules include integrations with social media platforms such as Twitter, Facebook, Instagram, SnapChat, TikTok, YouTube, Twitch, Discord, Reddit, and other platforms where people socialize and interact Online. Program modules also include integrations with browser APIs, storefront APIs, and advertisement displays.

Modules may control or manage user-input, database, and customization information and may receive data packet information. Some modules can function as an engine configured to transform data points from multimedia input sources and generate a customized character figure and story. Modules can include portions and functionalities located on a server and/or on a user device or computer system. Modules can be communicatively linked to engines, algorithms, and machine learning syntax and commands to generate customized character figures and stories.

User-input data and multimedia data may be derived from various input-output systems. Some input-output devices may include device controllers for one or more user interface input devices and/or user interface output devices. The devices may provide one or several outputs to a viewer by converting one or several electrical signals to the viewer in perceptible and/or interpretable form and may receive one or several inputs from the viewer by generating one or several electrical signals based on one or several viewer-caused interactions with the input-output system such as the depressing of a key or button, the moving of a mouse, the interaction with a touchscreen or trackpad, the interaction of a sound wave with a microphone, or the like.

In addition, data may be derived from, accessed, or edited by control devices such as a remote control, keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices, fingerprint scanners, barcode readers, and eye gaze tracking devices.

Multimedia display devices may be configured to receive and execute commands from social media, browser, content, and advertisement modules and from display control devices over one or more networks. Such applications may be web browser-based applications and/or standalone software applications such as social media platforms. Servers may be communicatively coupled with the display devices via one or more communication networks such as the Internet, television broadcast, or other content-delivery network.

Display devices may receive module applications from a server or froms other application providers such as public or private application stores. Servers may be configured to run one or more server software applications or services, for example, web-based or cloud-based services, to support content distribution and interaction with client devices to enable the display of contextually related social media and advertising content. In turn, viewers controlling and interacting with multimedia display devices may utilize one or more content modules to interact with a server to interact with the program for viewing, accessing, and interacting with social media, advertisement, browser, and multimedia content in an interrelated context.

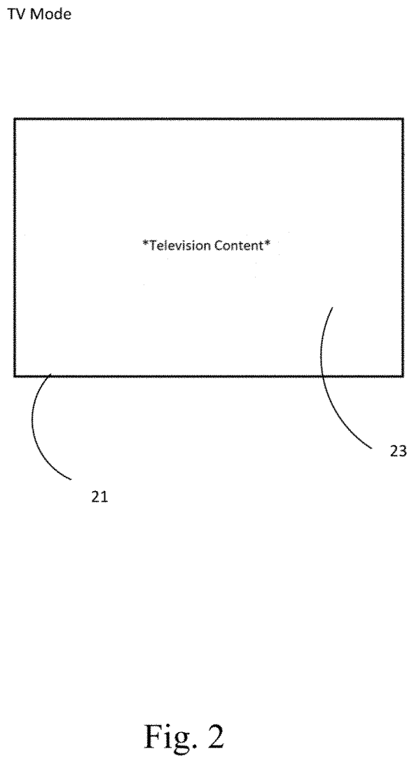

Referring now to FIG. 2, an exemplary television mode on a multimedia display device is shown. Television mode provides the viewer with a clean view of the multimedia content. User controls, navigation sections, module compartments, and module widgets are hidden. However, such additional widgets, navigation links, and functions can he accessed or toggled by selecting a corresponding control or navigation function on a control device.

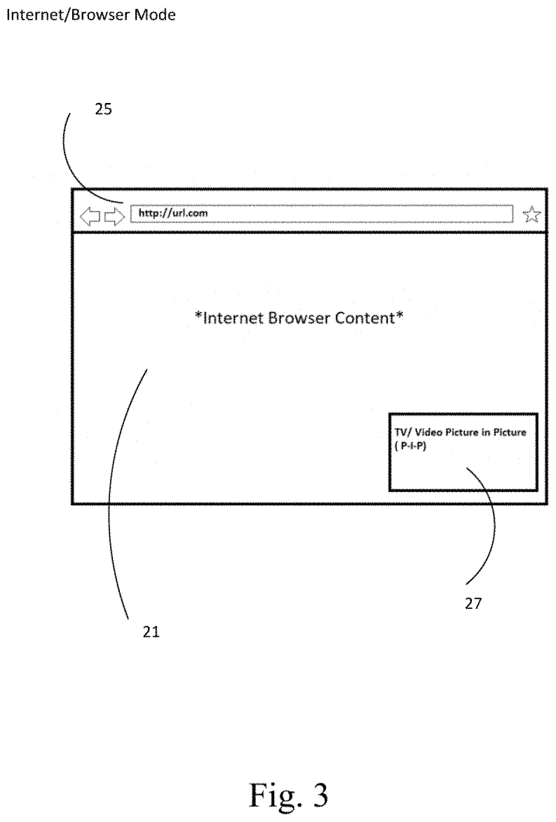

Referring now to FIG. 3, an exemplary Internet/browser mode on a multimedia display device is shown. In preferred displays, a television picture-in-picture configuration is displayed with the browser being the primary view and the television being the secondary view. The picture-in-picture window can be controlled conventionally with mute, pause, rewind, and fast forward for example. The picture-in-picture window can be moved and re-sized by selecting a cursor or control on a control device.

A viewer can watch a television show and research an aspect of that show simultaneously on the display screen. The systems may transmit data to and from browser APIs and databases. For example, a viewer may watch a history program pertaining to airplanes. The viewer becomes curious about the details of a specific airplane. The viewer uses a control device to toggle to browser mode to search for the specific airplane while either continuing to watch the multimedia content in the television display or pausing the television content. In some embodiments, a landing page or home screen may be pre-loaded to manufacturer specifications or may be customized according to viewer specifications.

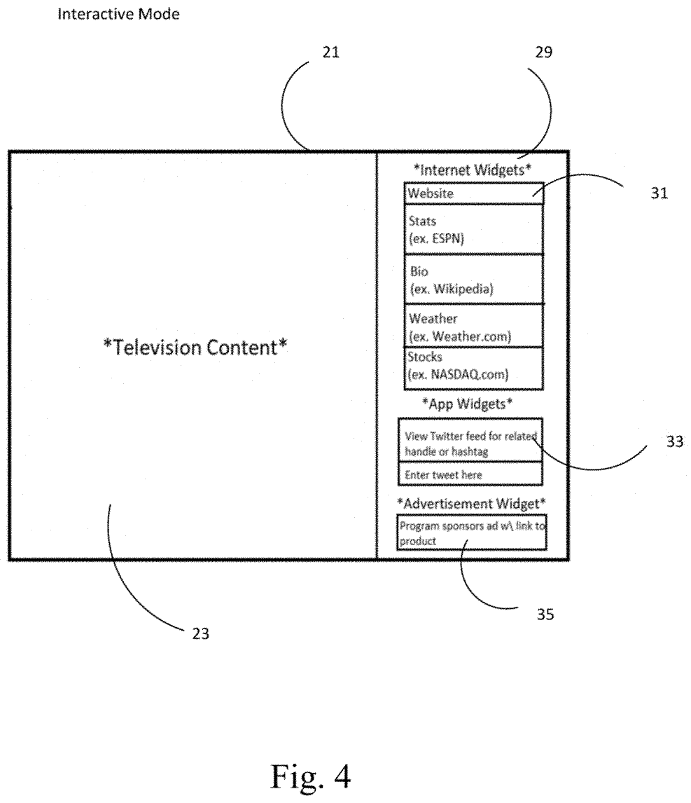

Referring now to FIG. 4, an exemplary interactive mode on a multimedia display device is shown. The multimedia content is the primary window in some versions but may be re-sized or moved depending on a viewer's preferred configuration. Similarly, content windows with widgets may by minimized, re-sized, expanded, hidden, revealed, added, or removed from the device display screen. Widgets may be shown in additional windows. In general, widgets push and pull data from APIs, databases, displays, and viewer control inputs. Widgets may be programmatically optimized for succinct display in a content window. There are Internet or browser widgets, application and social media widgets, and advertisement widgets. Exemplary Internet widgets may access real-time data feeds and may automatically update or may be manually selected, configured, and updated by a viewer.

The widget content may be contextually linked or related to the multimedia content. For example, the multimedia content may be a news program showing current events pertaining to a company in crisis in a particular region. A browser website widget may show that company's statistics in a fact window or way show the company's stock value and financial projections in another browser window.

In the same example, the company is a clothing retailer. The program modules and APIs may detect clothing items via artificial intelligence, machine learning, or audio or visual object identification to generate advertisements for relevant clothing. The advertisements may be displayed in a content window or idget. The viewer may interact with the advertisement. On the other hand, the advertisement may be contextually related on a more macro level. Since the multimedia content is a news program, the contextually related advertisement may be for a newspaper subscription. In another example, a news anchor may be wearing sponsored accessories such as a necklace. The product placement or sponsor advertisement may be accessed from a database and loaded into the content or advertisement widget window, so viewers can directly view, select, and purchase the same necklace.

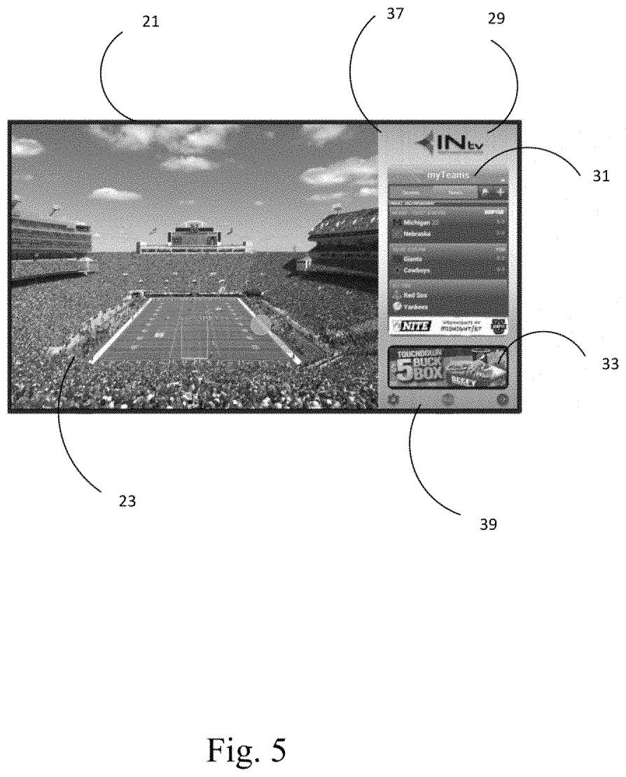

Referring now to FIG. 5, an exemplary schematic of multimedia content access, interaction, and display is shown. Generally, the content displayed is selected by a viewer and adapted the more the viewer interacts with the system. Each mode involves the sending and receiving and processing of multimedia data, advertisement data, browser functionality APIs, and device controls. The television broadcast section is separated twin the interactive content section by a partition. A navigation bar or navigation section may be present at the bottom of the interactive content section.

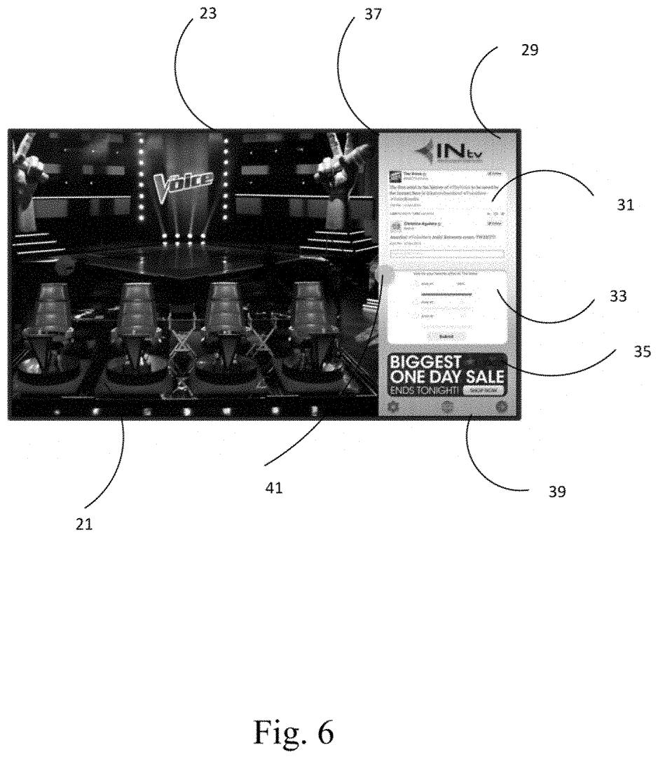

Referring now to FIG. 6, an alternative exemplary embodiment of multimedia content access, interaction, and display is shown. In this example, the television broadcast content is a contest show. The interactive section contains the corresponding social media feed that matches the contest show. The contest show invites audience interaction on its website. The corresponding voting widget is shown. An additional module, an advertisement with a hyperlink is also shown above a navigation panel.

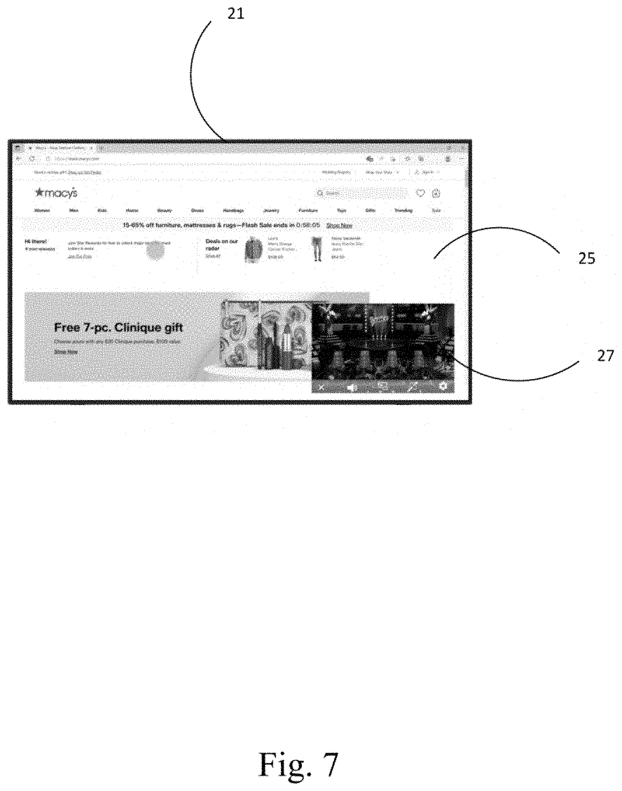

Referring now to FIG. 7 an exemplary browser with picture-in-picture display is shown. In this example, the viewer has selected or clicked on the advertisement hyperlink with a cursor. The display loads the browser view of the linked page from the advertisement and launches the television broadcast content into a picture-in-picture display.

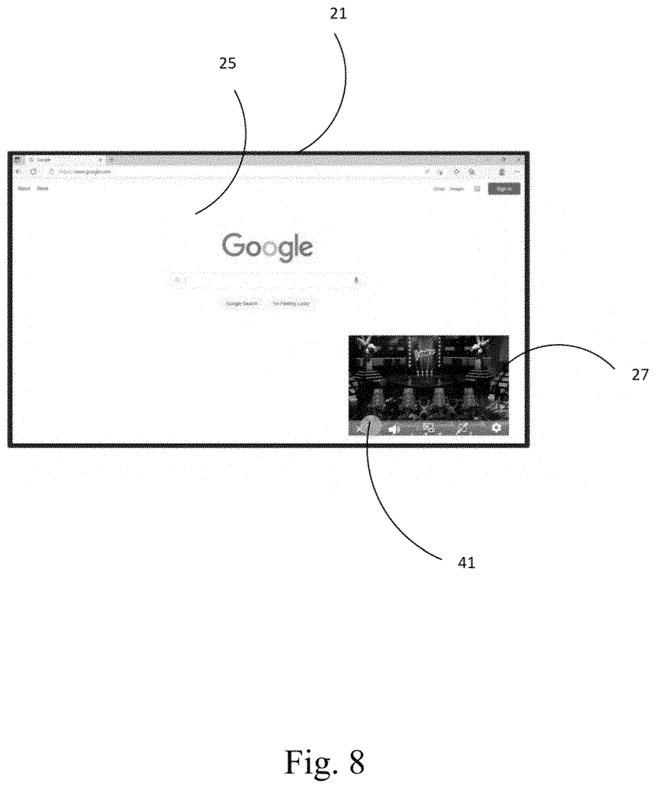

Referring now to FIG. 8 an alternative exemplary browser with picture-in-picture display is shown. In this example, the display loads a browser view agnostic to any specific content from the television broadcast content.

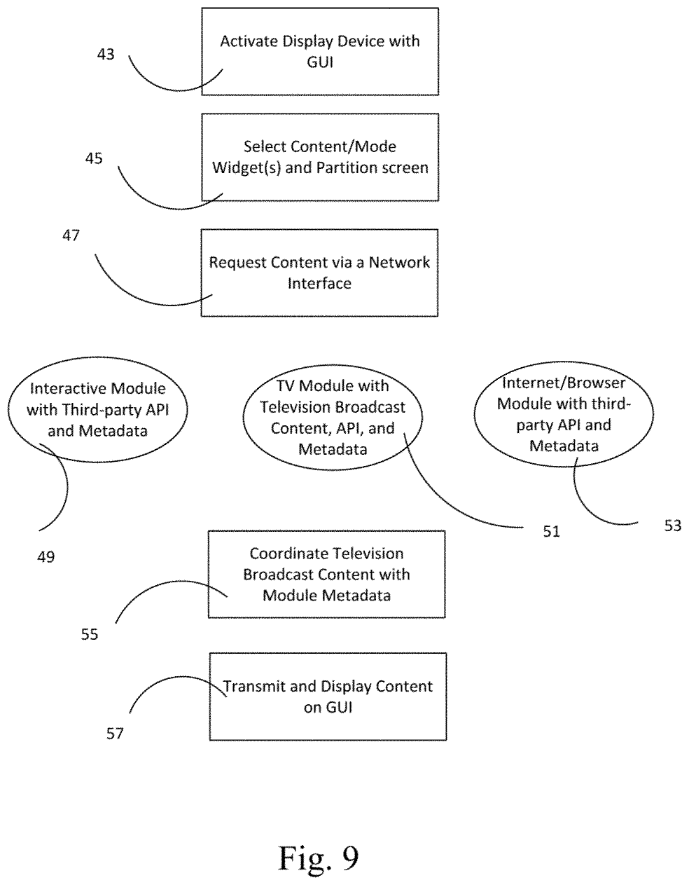

Referring now to FIG. 9 a schematic of programmatic instructions and content is shown.

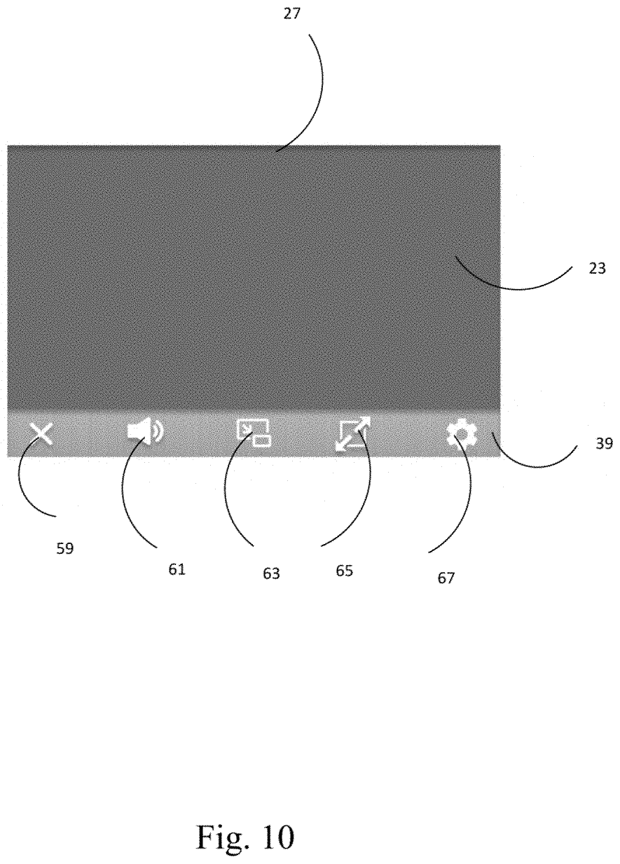

Referring now to FIG. 10 an exemplary picture-in-picture section interface is shown. The picture-in-picture display features a selection of navigation functions in a navigation bar or panel.

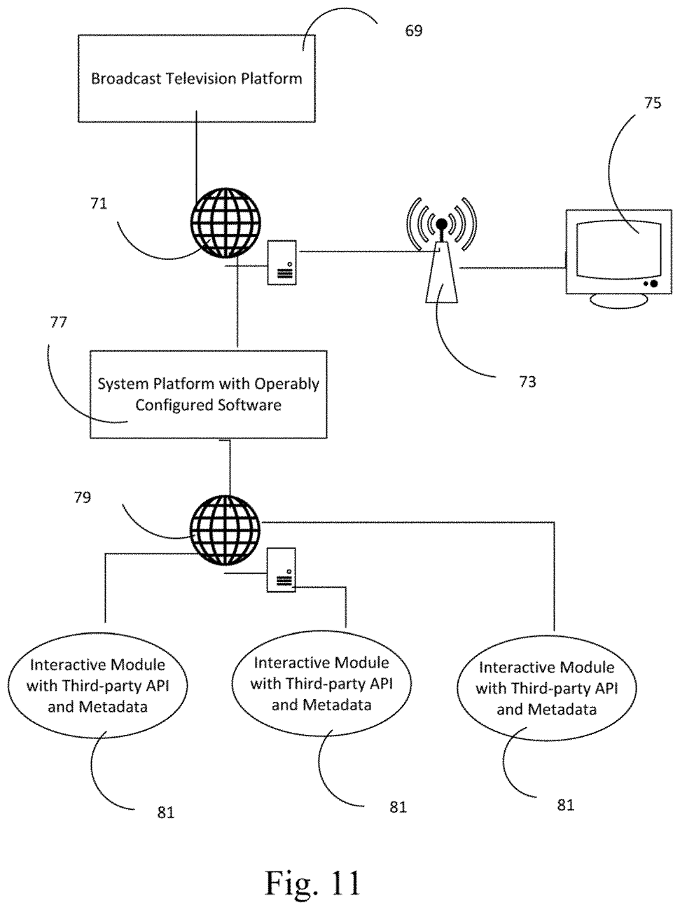

Referring now to FIG. 11 an exemplary schematic of integration of a system platform with a broadcast television platform is shown. In preferred embodiments, the content from the third-party modules is not directly transmitted to a television broadcast user interface. Instead, the system plattbrm of the disclosure having the operably configured software is integrated with the television broadcast platform via a network interface, and the third-party content is requested, returned, processed, and transmitted by the system platform processor. The processor is configured to request television broadcast content metadata from a television broadcast platform in wireless communication with the system platform over a network interface, receive television broadcast content metadata from the television broadcast platform via the network interface, transmit instructions to generate and display on the display device a graphical user interface having a partition between a broadcast content section and an interactive content section, identify third-party content modules, load a third-party content module having an API and metadata, and match context-specific metadata from the broadcast content metadata to content module metadata.

### Conclusion

A number of embodiments of the present disclosure have been described. While this specification contains many specific implementation details, these details should not be construed as limitations on the scope of any disclosures or of what may be claimed.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, various modifications may be made without departing from the spirit and scope of the claimed disclosure.

What is claimed is:

1. A system platform with operably configured software for generating on a display device an interactiveall multimedia graphical user interface containing a partition separating television broadcast content and interactive content having a contextual relationship, the system platform comprising a processor configured to execute programmatic instructions that when executed
request television broadcast content metadata from a television broadcast platform in wireless communication with the system platform over a network interface,
receive television broadcast content metadata from the television broadcast platform via the network interface,
transmit instructions to generate and display on the display device a graphical user interface having a partition between a broadcast content section and an interactive content section,
identify third-party content modules,
load a third-party content module having an API and metadata, and
match context-specific metadata from the broadcast content metadata to content module metadata.

2. The system platform of claim 1 wherein the third-party content module is an Internet browser.

3. The system platform of claim 1 wherein the third-party content module is an advertisement.

4. The system platform of claim 1 wherein the third-party content module is social media.

5. The system platform of claim 1 wherein the system platform is integrated into a television broadcast platform broadcastingcontent ora a display device and accessed by a viewer while viewing the television broadcast content.

6. The system platform of claim 5 wherein a viewer interacts with the display device in television mode.

7. The system of platform claim 5 wherein the viewer interacts kith the display device in browser mode.

8. The system platform of 5 wherein the viewer interacts with the display device in interactive mode.

9. The system of claim 1 further comprising a screen control device in communication with the display device.

10. A method of implemeimplementing a system platform with operably configured software for generating on a display device an interactive multimedia graphical user interface containing a partition separating teles ision broadcast content and interactive content having a contextual relationship, the method steps comprising
requesting television broadcast content metadata from a television broadcast platform in wireless communication with the system platform over a network interface,
receiving television broadcast content metadata from the television broadcast platform via the network interface,
transmitting instructions to generate and display the display device a graphical user interface having a partition between a broadcast content section nd an interactive content section,
identifying third-party content modules,
loading a third-party content modulo having an API and metadata, and
matching context-specific metadata from the broadcast content metadata to content module metadata.
